(19) United States
(12) Patent Application Publication
(10) Pub. No.: US 2015/0277624 A1
(43) Pub. Date: Oct. 1, 2015

(54) Sensing Method and Related Touch Panel

(71) Applicant: NOVATEK Microelectronics Corp., Hsin-Chu (TW)

(72) Inventor: Yun-Hsiang Yeh, Hsinchu County (TW)

(21) Appl. No.: 14/481,922

(22) Filed: Sep. 10, 2014

(30) Foreign Application Priority Data
Mar. 27, 2014 (TW) 103111558

(51) Int. Cl. G06F 3/044

(52) U.S. Cl. CPC G06F 3/044

(57) ABSTRACT

The present disclosure provides a detection method for a touch panel. The touch panel comprises a plurality of a first sensing electrode and a plurality of a second sensing electrode. The detection method comprises sensing a total self-capacitance of the first sensing electrodes, a plurality of self-capacitance of the second electrodes and a plurality of mutual capacitance when an object touches the touch panel; obtaining a plurality of self-capacitance of the first sensing electrodes according to the total self-capacitance of the first sensing electrodes, the self-capacitances of the second electrodes and the mutual capacitances and calculating coordinates of an object on the touch panel according to the self-capacitances of the first sensing electrodes.

### BACKGROUND OF THE INVENTION

1. Field of the Invention

The present invention relates to a sensing method and related touch panel, and more particularly to a sensing method of integrating a self-capacitance and a mutual-capacitance for a touch panel.

2. Description of the Prior Art

Touch screen devices provide an instinct and simple operation for a user so they have been widely used in all kind of consuming electronic products. General speaking, a touch screen device is composed of a transparent touch panel and a display device. By attaching the touch panel onto the display device, a touch function and display function can be carried out. Among various touch application, a capacitive touch panel has become the most popular.

The operation principle of the capacitive touch panel is that Indium tin oxide (ITO) electrodes on the touch panel generate a capacitance change due to the touch of a human finger or an object, which can be converted into readable coordinates for an operation system. The detailed operation of the capacitive touch panel can be referenced by U.S. Pat. No. 4,087,625 and US patent US 2010/0309167A1, which discloses a single layer ITO structure (triangle single-layer self-capacitance) to achieve single touch design.

Please refer to FIG. 1A, which is a triangle single layer self-capacitance touch panel 10. In FIG. 1A, the slashed blocks represent multiple sensing lines while the solid lines outside of the slashed blocks connect to a sensing chip. The main drawback of FIG. 1A is that the touch function can only work with a single finger plus a gesture because two or more fingers are not distinguishable at the fork part of the triangle shape. Please refer to FIG. 1B. When two fingers touch the touch panel on the same triangle channel, it is not able to distinguish one finger or two finger touch. In this situation, self-capacitance sensing method does not meet the requirement for multi-touch while reporting.

On the other hand, a single layer mutual capacitance is disclosed in the prior. For the single layer mutual capacitance, the coordinates cannot be retrieved by a touch on a single basic unit but a touch on two or more basic units will do the trick. The mutual capacitance may require more channels than the self-capacitance in the same size does. Please refer to FIG. 1C, which illustrates that the mutual capacitance adopts the same approach of proactively scanning for LCD. When a certain line on Y axis is scanned, the capacitance changes on all X axis are simultaneously sensed. The capacitance change on each intersection of X axis and Y axis can be obtained by scanning in an order. In this situation, the ghost points caused by the self-capacitance no longer exist. In theory, the number of coordinates is reported, depending on the number of the intersections of X axis and Y axis. Since the multi-touch consumes the system resource, more multi-touch points may need a faster control chip and have higher power consumption.

### SUMMARY OF THE INVENTION

It's therefore an objective of the present invention to provide a sensing method for a touch panel.

The present invention discloses a sensing method for a touch panel. The touch panel includes a plurality of first sensing electrodes and a plurality of second sensing electrodes. The first sensing electrodes and the second sensing electrodes forma plurality of sensing areas. The sensing method comprises sensing a total self-capacitance of the first sensing electrodes, a plurality of self-capacitances of the second electrodes and a plurality of mutual-capacitances of the sensing areas when an object touches the touch panel, wherein the first sensing electrodes are coupled to a common node while the second sensing electrodes are coupled to different nodes; obtaining a plurality of self-capacitances of the first sensing electrodes according to the total self-capacitance of the first sensing electrodes, the self-capacitances of the second electrodes and the mutual-capacitances of the sensing areas; and calculating coordinates of the object on the touch panel according to the self-capacitances of the first sensing electrodes.

The present invention further discloses a touch panel. The touch panel comprises a plurality of first sensing electrodes, a plurality of second sensing electrodes and a calculation unit. The first sensing electrodes are coupled to a common node, for detecting a total self-capacitance of the first sensing electrodes when an object touches the touch panel. Each first sensing electrode comprises at least one first convex part and at least one first concave part. The second sensing electrodes are couple to a plurality of nodes, for forming a plurality of sensing area with the first sensing electrodes and sensing a plurality of self-capacitance of the second sensing electrodes when the object touches the touch panel. Each second electrode comprises at least one second convex part and at least one second concave part. The calculation unit is used for obtaining a plurality of self-capacitances of the first electrodes according to the total self-capacitance of the first sensing electrodes, the self-capacitances of the second electrodes and a plurality of mutual-capacitances of the sensing area and calculating coordinates of the object on the touch panel according to the self-capacitances of the first sensing electrodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a triangle single layer self-capacitance touch panel in the prior art.

FIG. 1B illustrates that four channels inside a touch chip generate a signal corresponding to a capacitance change.

FIG. 1C illustrates that the mutual capacitance adopts the LCD device proactive scanning approach.

FIG. 2 is a schematic diagram of an exemplary sensing process.

FIG. 3 is an exemplary pattern of a touch panel.

FIG. 4 is an exemplary pattern of a touch panel.

FIG. 5 is an exemplary pattern of a touch panel.

FIG. 6 is an exemplary pattern of a touch panel.

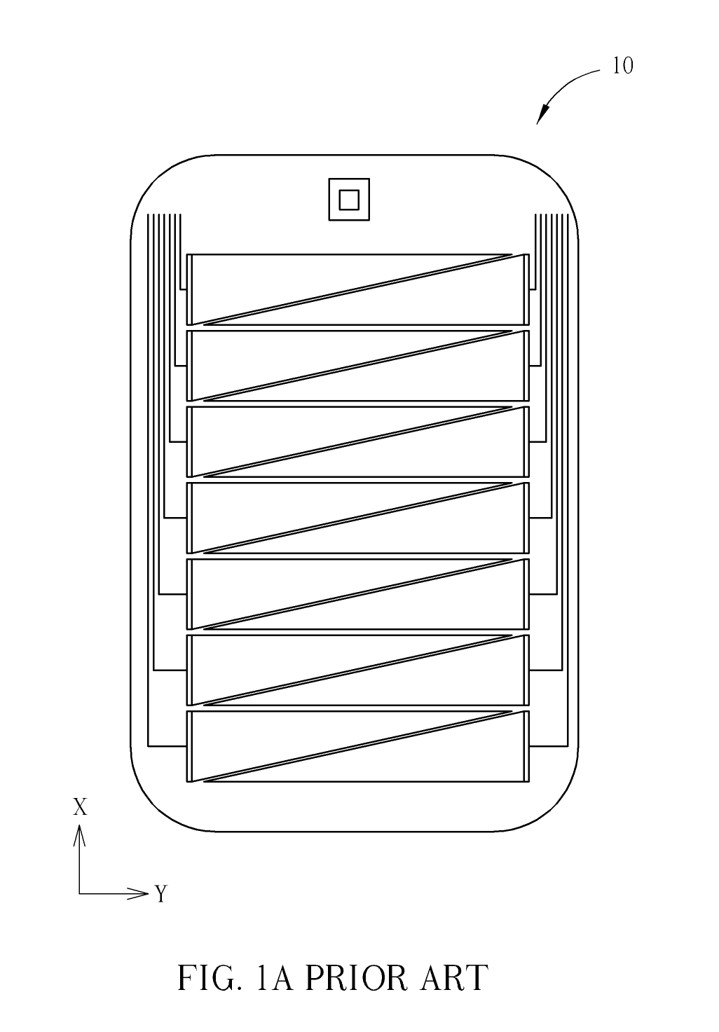

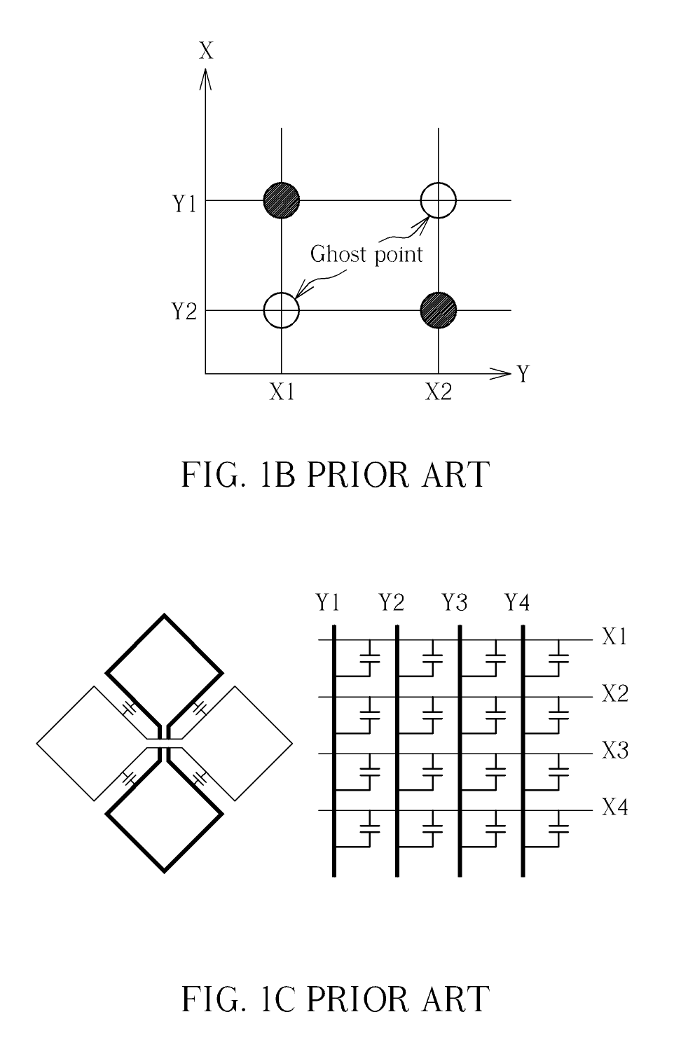

### DETAILED DESCRIPTION

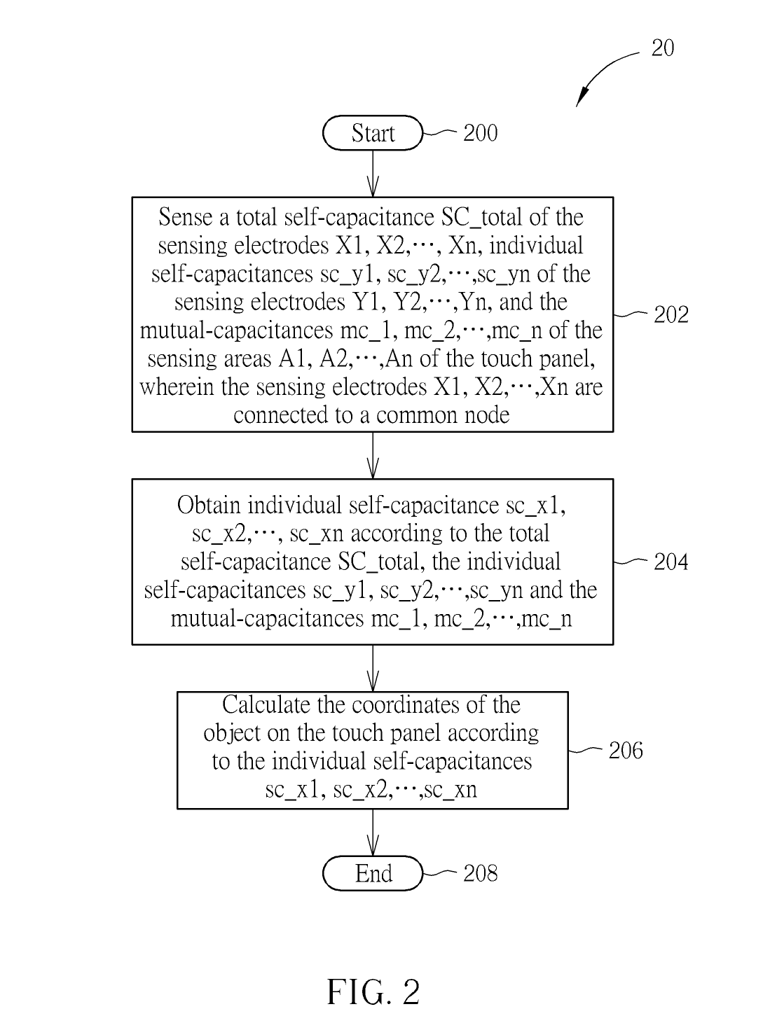

Please refer to FIG. 2, which is a schematic diagram of an exemplary sensing process 20. The sensing process 20 is used in a touch panel for detecting the coordinates of an object on the touch panel. The touch panel includes multiple sensing electrodes X1, X2, . . . , Xn and multiple sensing electrodes Y1, Y2, . . . , Yn, which form multiple sensing areas A1, A2, . . . , An. The sensing process 20 includes the following steps:

Step 200: Start.

Step 202: Sense a total self-capacitance SC_total of the sensing electrodes X1, X2, . . . , Xn, individual self-capacitances sc_y1, sc_y2, . . . , sc_yn of the sensing electrodes Y1, Y2, . . . , Yn, and the mutual-capacitances mc_1, mc_2, . . . , mc_n of the sensing areas A1, A2 , . . . , An of the touch panel, wherein the sensing electrodes X1, X2 , . . . , Xn are connected to a common node.

Step 204: Obtain individual self-capacitance sc_x1, sc_x2, . . . , sc_xn according to the total self-capacitance SC_total, the individual self-capacitances sc_y1, sc_y2, . . . , sc_yn and the mutual-capacitances mc_1, mc_2, . . . , mc_n.

Step 206: Calculate the coordinates of the object on the touch panel according to the individual self-capacitances sc_x1, sc_x2, . . . , sc_xn.

Step 208: End.

According to the process 20, the touch panel generates the capacitance change when the object (e.g. a finger or a stylus) touches the touch panel. The total self-capacitance SC_total of the sensing electrodes X1, X2, . . . , Xn, the individual self-capacitances sc_y1, sc_y2, . . . , sc_y3 of the sensing electrodes Y1, Y2, . . . , Yn, and the mutual-capacitances of the sensing areas A1, A2, . . . , An can be sensed through the sensing electrodes X1, X2, . . . , Xn and the sensing electrodes Y1, Y2, . . . , Yn and further the individual self-capacitances sc_x1, sc_x2, . . . , sc_xn can be calculated and obtained. According to the individual self-capacitances sc_x1, sc_x2, . . . , sc_xn, the example of the present disclosure can calculates the coordinates of the object on the touch panel. Please note that the way of calculating the coordinates of the object on the touch panel according to the self-capacitances sc_xl, sc_x2, . . . , sc_xn is well known by those in the art, and thus omitted herein. Briefly, the example of the present disclosure first senses the mutual-capacitances mc_1, mc_2, . . . , mc_n of the sensing areas A1, A2, . . . , An to roughly estimate which sensing area the object might be at. Given the total self-capacitance SC_total and the mutual capacitance of the certain sensing area, the self-capacitance of each sensing electrode in that sensing area can be calculated, and further the accurate coordinates can be obtained. In this situation, the example of the present disclosure can solve the problem that the single layer self-capacitance structure is not able to distinguish more than two fingers and achieve a better accuracy with less channels.

In addition, the sensing electrodes Y1, Y2, . . . , Yn are coupled to different nodes. Namely, each of the sensing electrodes Y1, Y2, . . . , Yn is independent. Each of the sensing electrodes X1, X2, . . . , Xn includes one or more first convex parts and one or more first concave parts while each of the sensing electrodes Y1, Y2, . . . , Yn includes one or more second convex parts and one or more second concave parts. To form the sensing areas A1, A2, . . . , An, the one or more first convex parts of each of the sensing electrodes X1, X2, . . . , Xn are embedded into the one or more second concave parts of each of the sensing electrodes Y1, Y2, . . . , Yn and the one or more second convex parts of each of the sensing electrodes Y1, Y2, . . . , Yn are embedded into the one or more first concave parts of each of the sensing electrodes X1, X2, . . . , Xn. Preferably, the shape of the one or more first convex parts, first concave parts, second convex parts, and second concave parts is a triangle, but not limited herein. In this situation, each of the sensing areas A1, A2, . . . , An is a triangle single layer self-capacitance unit.

On the other hand, the sensing electrodes X1, X2, . . . , Xn could be multiple sensing lines and the sensing electrodes Y1, Y2, . . . , Yn could be multiple driving lines. Or the sensing electrodes X1, X2, . . . , Xn could be multiple driving lines and the sensing electrodes Y1, Y2, . . . , Yn could be multiple sensing lines. Thus, the sensing electrodes X1, X2, . . . , Xn and the sensing electrodes Y1, Y2, . . . , Yn form a single layer mutual-capacitance unit. To put it simple, the example of the present disclosure integrates the sensing method of the single layer self-capacitance and the sensing method of the single layer mutual-capacitance. Since the sensing electrodes X1, X2, . . . , Xn are connected to a common node, the total self-capacitance is equal to the summation of the individual self-capacitances sc_x1, sc_x2, . . . , sc_xn of the sensing electrodes X1, X2, . . . , Xn.

Further, the self-capacitance of any of the sensing areas A1, A2, . . . , An is equal to the summation of self-capacitances of all sensing electrodes in that sensing area. For example, A self-capacitance sc_a1 of the sensing area A1 is equal to the summation of self-capacitances of the sensing electrodes X1 and Y1. Therefore, An equation can be obtained: sc_a1=sc_x+sc_y1, wherein sc_y1 is given. For the same token, the individual self-capacitances sc_a1, sc_a2, . . . , sc_an of the sensing areas A1, A2, . . . , An can be obtained.

Moreover, the ratio of the mutual-capacitance (e.g. the mutual-capacitance mc_1) of one sensing area, for example the sensing area A1, and the mutual-capacitance (e.g. the mutual-capacitance mc_2) of another sensing area, for example the sensing area A2, is equal to a ratio of the self-capacitance (e.g. sc_a1) of the sensing area A1 and the self-capacitance (e.g. sc_a2) of the sensing area A2. Namely, (mc_1/mc_2)=(sc_a1/sc_a2). Since sc_a1=sc_x1+sc_y1 and sc_a2=sc_x2+sc_y2, (sc_a1/sc a2)can be re-written as (sc_x1+sc_y1)/(sc_x2+sc_y2). Given the self-capacitance sc y1 of the sensing electrode Y1 and the self-capacitance sc_y2 of the sensing electrode Y2, the individual self-capacitances sc_x1 and sc_x2 of the sensing electrodes X1 and X2 can be derived from the equations above. By the same token, All self-capacitances sc_x1, sc_x2, . . . , sc_xn of the sensing electrodes X1, X2, . . . , Xn can be obtained.

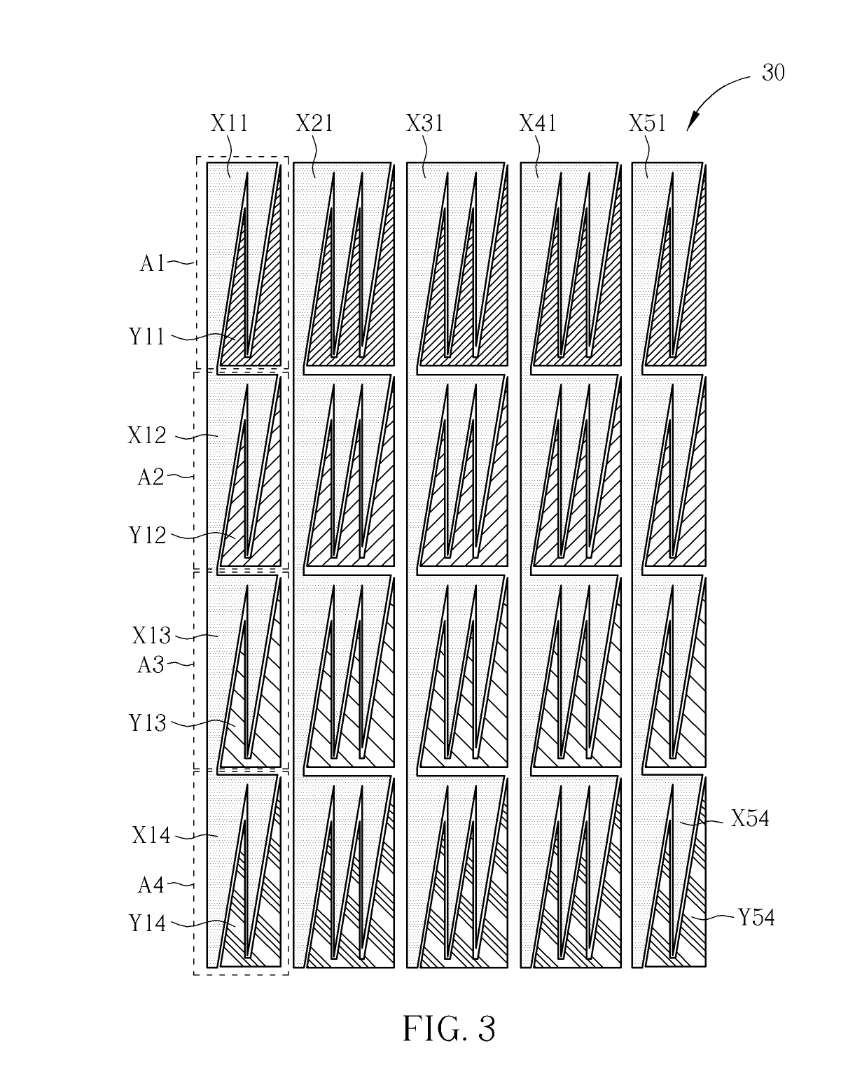

Please refer to FIG. 3, which is an exemplary pattern 30 of a touch panel. The pattern 30 includes sensing electrodes X11, X12, X13, . . . , X54 and sensing electrodes Y11, Y12, Y13, . . . , Y54. For simplicity, the sensing electrodes X11, X12, X13 and X14 in the first column are taken as an example. The sensing electrodes X11, X12, X13, X14 and the sensing electrodes Y11, Y12, Y13, Y14 form sensing areas A1, A2, A3, A4. The sensing electrodes X11, X12, X13, X14 are connected to a common node while the sensing electrodes Y11, Y12, Y13, Y14 are connected to different nodes, independently. When an object touches the touch panel, A total self-capacitance SC_total of the sensing electrodes X11, X12, X13, X14, the individual self-capacitances sc_y11, sc_y12, sc_y13, sc_y14 of the sensing electrodes Y11, Y12, Y13, Y14 and the mutual-capacitances mc_1, mc_2, mc_3, mc_4 of the sensing areas A1, A2, A3, A4 are sensed. Thus, equations (1), (2), (3), (4), (5) are derived:

SC_total=sc_{—}x11+sc_{—}x12+sc_{—}x13+sc_{—}x14 (1)

(mc_{—}1/mc_{—}2)=(sc_{—}x11+sc_{—}y11)/(sc_{—}x12+sc_{—}y12) (2)

(mc_{—}2/mc_{—}3)=(sc_{—}x12+sc_{—}y12)/(sc_{—}x13+sc_{—}y13) (3)

(mc_{—}3/mc_{—}4)=(sc_{—}x13+sc_{—}y13)/(sc_{—}x14+sc_{—}y14) (4)

(mc_{—}1/mc_{—}4)=(sc_{—}x11+sc_{—}y11)/(sc_{—}x14+sc_{—}y14) (5)

Through a system of the equations (1), (2), (3), (4), (5), the self-capacitances sc_x11, sc_x12, sc_x13, sc_x14 of the sensing electrodes X11, X12, X13, X14 can be obtained. Then, the coordinates of the object on the touch panel can be calculated according to the individual self-capacitances sc_x11, sc_x12, sc_x13, sc_x14 of the sensing electrodes X11, X12, X13, X14.

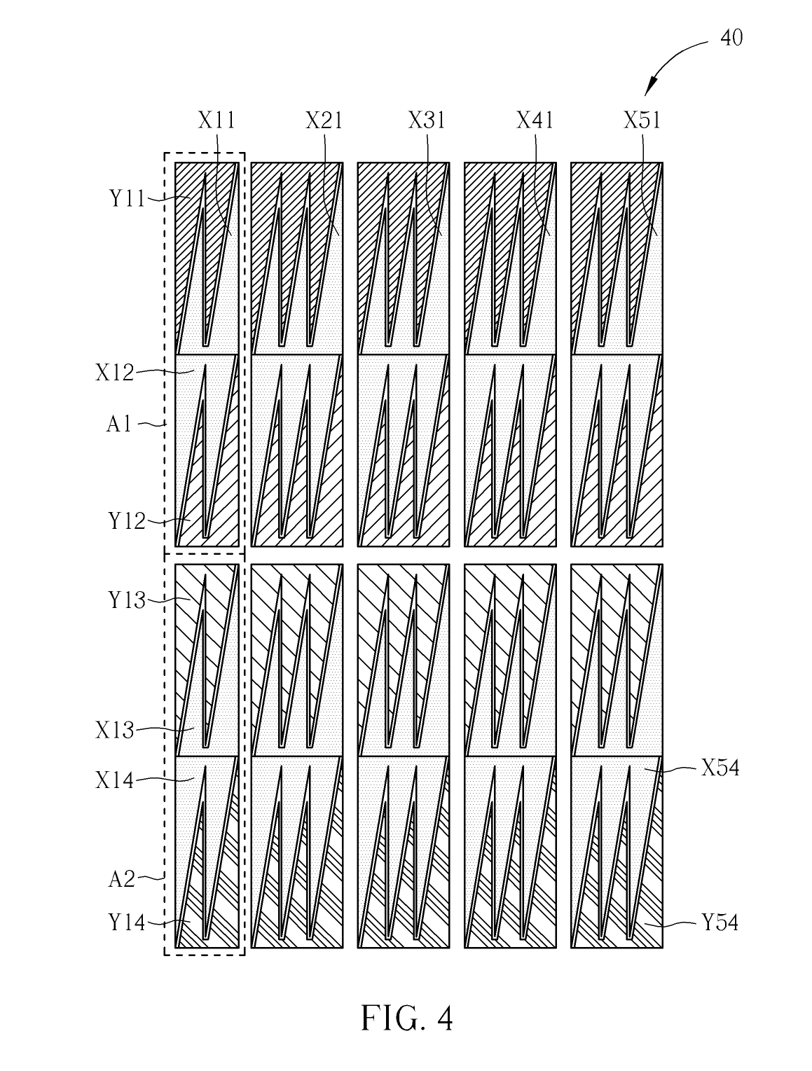

Please refer to FIG. 4, which is an exemplary pattern 40 of a touch panel. The pattern 40 includes the sensing electrodes X11, X12, X13, . . . , X54 and the sensing electrodes Y11, Y12, Y13, . . . , Y54. For simplicity, the sensing electrodes X11, X12, X13, X14 and the sensing Y11, Y12, Y13, Y14 are taken as an example. The sensing electrodes X11, X12, X13, X14 and the sensing electrodes Y11, Y12, Y13, Y14 form the sensing areas A1, A2, A3, A4. The sensing electrodes X11, X12 are connected to a common node, and the sensing electrodes X13, X14 are connected to another common node. The sensing electrodes Y11, Y12, Y13, Y14 are connected to different nodes independently. For simplicity, only the sensing areas A1, A2 are taken as an example. When an object touches the touch panel, A total self-capacitance SC_total, individual self-capacitances sc_y11, sc_y12 of the sensing electrodes Y11, Y12, the mutual-capacitances mc_1, mc_2 of the sensing areas A1, A2 can be obtained. Thus, equations (1′), (2′) can be derived:

SC_total=sc_{—}x11+sc_{—}x12 (1′)

(mc_{—}1/mc_{—}2)=(sc_{—}x11+sc_{—}y11)/(sc_{—}x12+sc_{—}y12) (2′)

Through a system of equations (1′), (2′) above, the individual self-capacitances sc_x11, sc_x12 of the sensing electrodes X11, X12 can be obtained. Then, the individual self-capacitances sc_x13, sc_x14 can be obtained by the same token. The coordinates of the object on the touch panel can be calculated according the individual self-capacitances sc_x11, sc_x12, sc_x13, sc_x14.

Please note that the main purpose of the present disclosure is to obtain the individual self-capacitances sc_x11, sc_x12, sc_x13, sc_x14 of the sensing electrodes X11, X12, X13, X14 according to the total self-capacitance, the self-capacitances sc_y11, sc_y12, sc_y13, sc_y14 and the mutual-capacitances mc_1, mc_2, mc_3, mc_4, and further calculate the coordinates of the object according to the individual self-capacitances sc_x11, sc_x12, sc_x13, sc_x14 of the sensing electrodes X11, X12, X13, X14. Therefore, A pattern of the touch panel is not limited to the patterns 30 and 40, and the number of the electrodes in the patterns 30 and 40 is not limited herein.

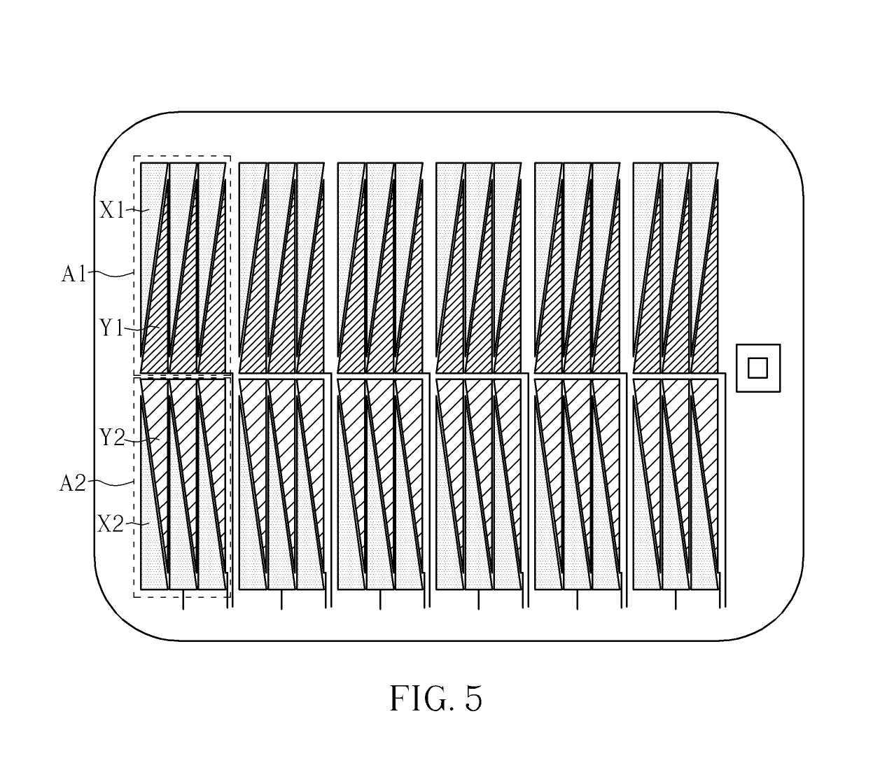

Please refer to FIG. 5, which is an exemplary pattern 50 of a touch panel. The pattern 50 includes sensing electrodes X1, X2 and sensing electrodes Y1, Y2. The sensing electrodes X1, X2 and the sensing electrodes Y1, Y2 form sensing areas A1, A2. The sensing electrodes X1, X2 are connected to a common node and the sensing electrodes Y1, Y2 are connected to different nodes, independently. The way of calculating the individual self-capacitances sc_x1, sc_x2 can be found above, and thus omitted herein.

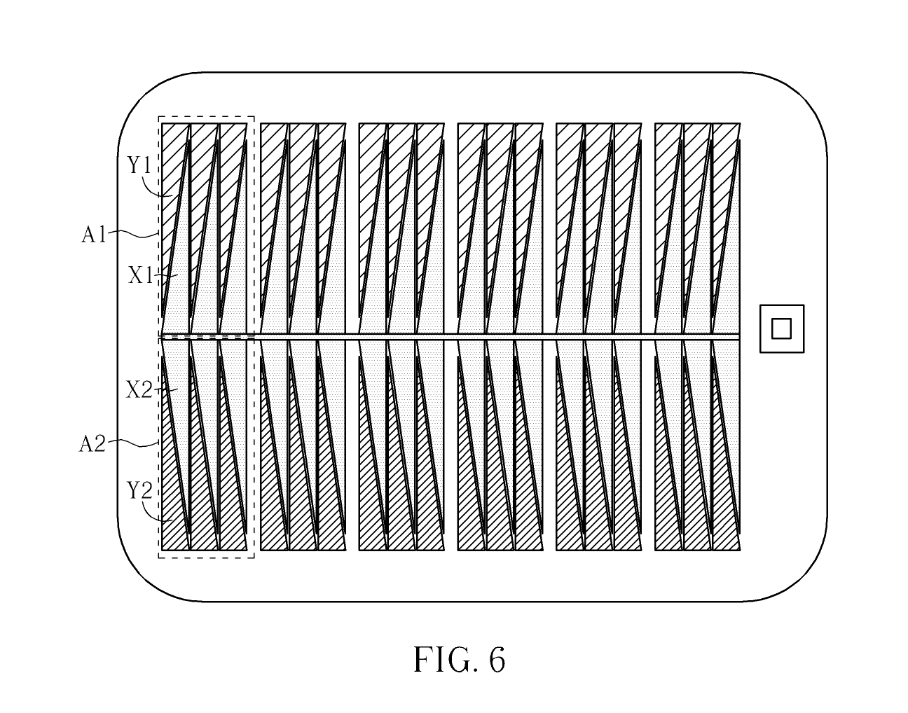

Please refer to FIG. 6, which is an exemplary pattern 60 of a touch panel. The pattern 60 includes sensing electrodes X1, X2 and sensing electrodes Y1, Y2. The sensing electrodes X1, X2 and the sensing electrodes Y1, Y2 form sensing areas A1, A2. The sensing electrodes X1, X2 are connected to a common node and to the electrodes X3˜Xn. The sensing electrodes Y1, Y2 are connected to different nodes, independently. The way of calculating the individual self-capacitances sc_xl, sc_x2 can be found above, and thus omitted herein.

To sum up, the examples of the present disclosure integrate the sensing method of the single layer self-capacitance and the sensing method of the single layer mutual-capacitance so the drawbacks of the single layer self-capacitance and the single layer mutual-capacitance are compensated. Compared to the single layer self-capacitance sensing, the present disclosure achieves the multi-touch with the least channel. Compared to the mutual-capacitance sensing, the present disclosure have a better accuracy in the condition of the same channel number.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sensing method for a touch panel, the touch panel comprising a plurality of first sensing electrodes and a plurality of second sensing electrodes, the first sensing electrodes and the second sensing electrodes forming a plurality of sensing areas, the sensing method comprising:
sensing a total self-capacitance of the first sensing electrodes, a plurality of self-capacitances of the second electrodes and a plurality of mutual-capacitances of the sensing areas when an object touches the touch panel, wherein the first sensing electrodes are coupled to a common node while the second sensing electrodes are coupled to different nodes;
obtaining a plurality of self-capacitances of the first sensing electrodes according to the total self-capacitance of the first sensing electrodes, the self-capacitances of the second electrodes and the mutual-capacitances of the sensing areas; and
calculating coordinates of the object on the touch panel according to the self-capacitances of the first sensing electrodes.

2. The sensing method of claim 1, wherein at least one first convex part of one of the first sensing electrodes is embedded in at least one second concave part of one of the second sensing electrodes and at least one second convex part of the second sensing electrode is embedded in at least one first concave part of the first sensing electrode, to form one of the sensing areas.

3. The sensing method of claim 2, wherein the at least one first convex part, the at least one first concave part, the at least one second convex part and the at least one first concave part are a triangle.

4. The sensing method of claim 1, wherein the first sensing electrodes are a plurality of sensing lines and the second sensing electrodes are a plurality of driving lines.

5. The sensing method of claim 1, wherein the first sensing electrodes are a plurality of driving lines and the second sensing electrodes are a plurality of sensing lines.

6. The sensing method of claim 1, wherein the total self-capacitance is equal to a summation of the first self-capacitances of the first electrodes.

7. The sensing method of claim 1, wherein a self-capacitance of one of the sensing areas is equal to a summation of a self-capacitance of a first sensing electrode of the sensing area and a self-capacitance of a second sensing electrode of the sensing area.

8. The sensing method of claim 1, wherein a ratio of a first sensing area and a second sensing area is equal to a ratio of a self-capacitance of the first sensing area and a self-capacitance of the second sensing area.

9. A touch panel, comprising:
a plurality of first sensing electrodes coupled to a common node, for detecting a total self-capacitance of the first sensing electrodes when an object touches the touch panel, each first sensing electrode comprising:
at least one first convex part; and
at least one first concave part;
a plurality of second sensing electrodes couple to a plurality of nodes, for forming a plurality of sensing area with the first sensing electrodes and sensing a plurality of self-capacitance of the second sensing electrodes when the object touches the touch panel, each second electrode comprising:
at least one second convex part; and
at least one second concave part; and
a calculation unit, for obtaining a plurality of self-capacitances of the first electrodes according to the total self-capacitance of the first sensing electrodes, the self-capacitances of the second electrodes and a plurality of mutual-capacitances of the sensing area and calculating coordinates of the object on the touch panel according to the self-capacitances of the first sensing electrodes.

10. The touch panel of claim 9, wherein at least one first convex part of one of the first sensing electrodes is embedded in at least one second concave part of one of the second sensing electrodes and at least one second convex part of the second sensing electrode is embedded in at least one first concave part of the first sensing electrode, to form one of the sensing areas.

11. The touch panel of claim 10, wherein the at least one first convex part, the at least one first concave part, the at least one second convex part and the at least one first concave part are a triangle.

12. The touch panel of claim 9, wherein the first sensing electrodes are a plurality of sensing lines and the second sensing electrodes are a plurality of driving lines.

13. The touch panel of claim 9, wherein the first sensing electrodes are a plurality of driving lines and the second sensing electrodes are a plurality of sensing lines.

14. The touch panel of claim 1, wherein the total self-capacitance is equal to a summation of the first self-capacitances of the first electrodes.

15. The touch panel of claim 1, wherein a self-capacitance of one of the sensing areas is equal to a summation of a self-capacitance of a first sensing electrode of the sensing area and a self-capacitance of a second sensing electrode of the sensing area.

16. The touch panel of claim 1, wherein a ratio of a first sensing area and a second sensing area is equal to a ratio of a self-capacitance of the first sensing area and a self-capacitance of the second sensing area.
